(19) United States
(12) Patent Application Publication
(10) Pub. No.: US 2026/0318284 A1
(43) Pub. Date: Oct. 15, 2026

(54) WIND TURBINE BLADE HAVING AN ELECTRO-THERMAL SYSTEM

(71) Applicant: LM WIND POWER A/S, Kolding (DK)

(72) Inventors: Mark HANCOCK, Eastleigh Hampshire (GB); Lars Bo HANSEN, Kolding (DK); Victor MIRANDA, Kolding (DK)

(21) Appl. No.: 19/116,659

(22) PCT Filed: Sep. 22, 2023
(86) PCT No.: PCT/EP2023/076234

§ 371 Date: Mar. 28, 2025

(30) Foreign Application Priority Data
Sep. 29, 2022 (EP) 22198704.3

(51) Int. Cl. F03D 80/40; F03D 1/06; F03D 80/30

(52) U.S. Cl. CPC F03D 80/401; F03D 1/0681; F03D 80/301; F05B 2230/60

(57) ABSTRACT

A wind turbine blade comprising suction and pressure side shell parts of an aerodynamic shell body extending in a longitudinal direction between a root end and a tip end and in a transverse direction between a leading edge and a trailing edge, and an electro-thermal system comprising suction and pressure side heating layers comprising electrically conductive fibres to mitigate ice formation on the wind turbine blade; suction and pressure side metallic lightning protection layers for receiving a lightning strike and arranged exteriorly to and overlapping the heating layers; and a down conductor being electrically connected to the metallic lightning protection layers so as to be able to conduct a lightning strike current from the metallic lightning protection layers to a root of the wind turbine blade, wherein the electro-thermal system comprises at least one equipotential bonding conductor electrically connecting the electrically conductive fibres of the suction side heating layer and the electrically conductive fibres of the pressure side heating layer to form an equipotential bonding;

### TECHNICAL FIELD

The present invention relates to a wind turbine blade having an electro-thermal system.

### BACKGROUND

When wind turbines are operated in cold-weather climates, the potential build-up of ice on the wind turbine blades presents challenges for turbine performance. In a first aspect, any ice formation on the blade surfaces will disrupt the blade aerodynamics, which may lead to a reduction in turbine efficiency and/or increased operational noise levels. In a further aspect, ice which breaks away from blade surfaces can present a falling hazard. In this regard, wind turbine blades in such locations are often provided with systems to deliver ice prevention and/or removal.

It is known to provide hot-air electro-thermal systems which operate on the principle of supplying heated air to the interior of a wind turbine blade to raise the surface temperature of the blade to above freezing. An example of such a hot-air electro-thermal system can be seen in US Patent Application Publication No. US 2013/0106108.

It is also known to utilise electrical heating systems embedded in blades and mechanical electro-thermal systems. However, including conductive materials in the blade comes with the risk of a lightning strike attaching to these conductive materials, especially when the conductive materials are included near the tip of the blade as this region of the blade is at high risk of lightning strikes. For electrical heating systems there is a need for lightning protection with reduced surface disturbance to avoid reducing annual energy production. Accordingly, there is a need for new solutions.

### SUMMARY

On this background, it may be seen as an object of the present disclosure to provide a wind turbine blade having an electro-thermal system which overcomes or ameliorates at least one of the disadvantages of the prior art or which provides a useful alternative.

One or more of these objects may be met by aspects of the present disclosure as described in the following.

A first aspect of this disclosure relates to a wind turbine blade comprising an aerodynamic shell body forming an exterior surface of the wind turbine blade and an electro-thermal system for mitigating ice formation on the wind turbine blade. The aerodynamic shell body extends in a longitudinal direction between a root end and a tip end, and in a transverse direction between a leading edge and a trailing edge. The aerodynamic shell body comprises a suction side shell part, a pressure side shell part, and a longitudinally extending bond line between the suction side shell part and the pressure side shell part. The bond line preferably extends along the leading edge and/or the trailing edge of the aerodynamic shell body. The electro-thermal system comprises:
a suction side heating layer forming part of the suction side shell part of the aerodynamic shell body, the suction side heating layer comprising electrically conductive fibres arranged at least in a leading edge section of the suction side shell part;
a pressure side heating layer forming part of the pressure side shell part of the aerodynamic shell body, the pressure side heating layer comprising electrically conductive fibres arranged at least in a leading edge section of the pressure side shell part;
preferably a power cable configured for supplying power to the suction and pressure side heating layers and configured for being connected to a power source, wherein the electrically conductive fibres of the heating layers are preferably configured for, upon receiving electrical power from the power source, e.g. via the power cable, supplying resistive heating to the exterior surface of the wind turbine blade preferably so as to mitigate, such as to melt or prevent, ice formation on the wind turbine blade;
a suction side metallic lightning protection layer arranged exteriorly to and overlapping the suction side heating layer and being configured for conducting current from a lightning strike;
a pressure side metallic lightning protection layer arranged exteriorly to and overlapping the pressure side heating layer and being configured for conducting current from a lightning strike; and
a down conductor having a first end arranged at the root of the wind turbine blade configured for being earthed, the down conductor being electrically connected to the suction and pressure side metallic lightning protection layers preferably so as to be able to conduct a lightning strike current from the suction and pressure side metallic lightning protection layers to the first end of the down conductor;

wherein a leading edge of the suction side heating layer and a leading edge of the pressure side heating layer are arranged adjacent to the bond line and are separated by a distance transverse to the bond line, wherein the electro-thermal system comprises at least one equipotential bonding conductor electrically connecting the electrically conductive fibres of the suction side heating layer and the electrically conductive fibres of the pressure side heating layer so as to form equipotential bonding of the suction side heating layer and the pressure side heating layer.

During a lightning strike, the lightning current has an exceptionally fast rise time which typically causes a potential difference between the suction side heating layer and the pressure side heating layer. Since the heating layers are separated by the bond line, a flashover event can occur between the heating layers if the potential difference is too large. Advantageously, by including the at least one equipotential bonding conductor, this potential difference between the heating layers can be reduced.

This may provide several advantages. First, the risk of a flash over the leading edge between the heating layers may be reduced. Second, the distance between the heating layers at the leading edge may be narrowed resulting in an increased heat transfer at the leading edge and thus an increased ice mitigation capability. Third, the extent of the heating layers can be increased towards the trailing edge to increase the ice-mitigated area of the wind turbine blade.

Additionally or alternatively, the wind turbine blade may comprise a suction side spar cap and a pressure side spar cap. A spar cap may also be known as a main laminate. A spar cap may be integrated in the respective shell part or may form part of a separately provided spar, e.g. a box spar. The spar caps may comprise or consist essentially of electrically conductive fibres, such as a carbon fibre composite material, e.g. in the form of infused and cured carbon fibre sheets or carbon fibre pultrusions. The suction side heating layer may be arranged to overlap at least partially, optionally entirely, with the suction side spar cap, and/or the pressure side heating layer may be arranged to overlap at least partially, optionally entirely, with the pressure side spar cap. In this context, the overlap is seen perpendicularly to the exterior surface of the wind turbine blade. In other words, the suction side heating layer and/or the pressure side heating layer may extend between the distance from the bond line at the leading edge to the respective spar cap, and optionally beyond the respective spar cap towards the trailing edge. Such an overlap may increase the potential difference between heating layers e.g. during a lightning strike but may be mitigated by the inclusion of the at least one equipotential bonding conductor.

Thus, the at least one equipotential bonding conductor may form an electrical connection separately from the power cable (including any conductors of the power cable). Additionally or alternatively, the at least one equipotential bonding conductor may be arranged at a distance from a connection between the power cable and a root portion of the suction and pressure side heating layers and arranged at a distance from a connection between the power cable and a tip portion of the suction and pressure side heating layers.

Additionally or alternatively, the at least one equipotential bonding conductor forms part of a plurality of equipotential bonding conductors distributed along the longitudinal direction between the root portion and the tip portion of the suction and pressure side heating layers.

Additionally, the distance along the longitudinal direction between adjacent equipotential bonding conductors of the plurality of equipotential bonding conductors may be at most 20 metres, preferably at most 15 metres, more preferably at most 10 metres, most preferably at most 5 metres.

Additionally or alternatively, the at least one equipotential bonding conductor may comprise at least one trailing edge equipotential bonding conductor (or a plurality of trailing edge equipotential bonding conductors) arranged at the trailing edge, e.g. in a trailing edge section of the suction and pressure side shell parts. Such a conductor is abbreviated as a TE-EB conductor. For example, the trailing portion of the aerodynamic shell body extends from the spar caps (or a line of maximum thickness of the aerodynamic shell body) to the trailing edge.

Additionally, the TE-EB conductor(s) may comprise a suction side conductor and a pressure side conductor. The suction side conductor may be electrically connected to the electrically conductive fibres of the suction side heating layer and may be embedded in the suction side shell part. The pressure side conductor layer may be electrically connected to the electrically conductive fibres of the pressure side heating layer and may be embedded in the pressure side shell part. Embedding the conductors may provide an advantageous manufacturing process in which the conductors can be included in the layup of the other layers of the respective shell part. The suction side heating layer may be electrically connected to a leading portion of the suction side conductor, and the pressure side heating layer may be electrically connected to a leading portion of the pressure side conductor. This may be achieved for example by laminating the metallic conductive layer adjacent to the respective heating layer which may provide a good electrical contact to the respective heating layer. The conductors, including the leading portion thereof, may be distanced from the spar caps (and may thus not overlap). In other embodiments, one or both the conductors, including the leading portions thereof, may overlap at least partially, optionally entirely, with the corresponding spar cap or the spar caps, respectively. The leading portions of the conductors may be a portion arranged closer to the leading edge of the wind turbine blade (but preferably be distanced from the leading edge of the wind turbine blade), and the trailing portions of the conductors may be a portion arranged closer to the trailing edge of the wind turbine blade.

The suction side conductor and/or the pressure side conductor may be a conductor layer and may be made of a metal or a plastic material. For example a metallic mesh, such as a copper, aluminium, steel, or bronze mesh, or a conductive plastic, e.g. intrinsically conductive or comprising carbon black, and may be in the form of a strip. Preferably the suction side conductor and the pressure side conductors are strips of copper mesh.

Additionally or alternatively, the TE-EB conductor comprises suction and pressure side connector parts arranged in electrical contact with the respective conductor, e.g. a trailing portion of the respective conductor. The connector parts may each comprise a solid conductive part that may be in the form of a relatively thin element, such as a plate or a disc, and may include a threaded element, e.g. a nut. The solid conductive part may be embedded within the respective shell part, e.g. on an outer side of the respective conductor. The solid conductive part may comprise, or consist essentially of, a metal, such as bronze or copper.

The TE-EB conductor(s) may further comprise a bridging device electrically connecting a trailing portion of the suction side conductor and a trailing portion of the pressure side conductor, preferably via the respective solid connector parts. The bridging device may comprise a bridging conductor (e.g. a cable) extending from the suction side connector part to the pressure side connector part. The bridging conductor may be arranged with slack which allows the relatively flexible suction and pressure sides of the aerodynamic shell body near the trailing edge to flex in a thickness direction due to varying air pressures without compromising the function of the TE-EB conductor(s). The bridging conductor may be encapsulated in a cavity, e.g. a hole, of a block arranged between the interior sides of the suction side shell part and the pressure side shell part. The block may advantageously be made of a resilient material, e.g. of a foamed polymer, preferably configured to allow suction and pressure sides of the aerodynamic shell body at the trailing edge to flex in a thickness direction due to varying air pressures. Additionally or alternatively, the bridging conductor may be connected to the respective outer solid connector part. Further, a braiding of the cable may be spread out onto the solid connector parts at both ends of the bridging device to ensure a good electrical contact.

Alternatively, the bridging device may be a bolt. In such case, the trailing portion of the suction side conductor and the trailing portion of pressure side conductor may extend to a location adjacent to the trailing edge which has a thickness of at most 20 cm, preferably at most 15 cm, more preferably at most 10 cm. A head of the bolt may be arranged in electrical contact with one of the trailing portions of the suction side conductor and the trailing portion of the pressure side conductor, preferably the connector part of the trailing portion of the respective conductor. An end arranged opposite of the head of the bolt may be arranged in electrical contact with the other one of the trailing portions of the suction side conductor and the trailing portion of the pressure side conductor, preferably the connector part of the trailing portion of the respective conductor, which may preferably comprise a nut for engaging and establishing electrical contact with the end of the bolt.

Additionally or alternatively, the trailing portion of the suction and pressure side conductors of the TE-EP conductor(s) may extend entirely to the trailing edge. A connector part of the suction side conductor may define the trailing edge of the suction side conductor. A connector part of the pressure side conductor may define the trailing edge of the pressure side conductor. The connector parts may be a solid conductive material, e.g. a solid metal plate. A spacer of the bridging device may be sandwiched between the trailing edge of the suction side conductor and the trailing edge of the pressure side conductor. The spacer may be a metallic spacer and may thus define a bridging conductor of the bridging device. In addition or alternative to the spacer being metallic, the bridging conductor of the bridging device may comprise one or more conductive tabs extending through the suction side conductor (e.g. the connector part of the suction side conductor), the spacer, and the pressure side conductor (e.g. the connector part of the pressure side conductor). The suction side conductor may be embedded in the suction side shell part and the pressure side conductor may be embedded in the pressure side shell part. The spacer may be arranged between the suction and pressure side conductors during closure of the suction and pressure side shell parts. Optionally the one or more conductive tabs may be inserted through one or more respective holes extending through the suction and pressure side conductors and optionally the bridging conductor. The holes may either be pre-drilled prior to the closure of the shell parts or be drilled after closing the suction and pressure side shell parts. In some embodiments, the spacer may be omitted to achieve a thinner trailing edge of the wind turbine blade.

Additionally or alternatively, the at least one equipotential bonding conductor may comprise at least one leading edge equipotential bonding conductor (or a plurality of equipotential bonding conductors) arranged at the leading edge, e.g. in the leading edge section of the suction and pressure shell parts. Such a conductor is abbreviated as an LE-EB conductor. The LE-EB conductor may be in the form of a strip and may comprise or consist essentially of a conductive material. The conductor material may be a flexible material, such as conductive fibres, e.g. carbon fibres, or a mesh, such as a copper, aluminium, or bronze mesh.

Additionally or alternatively, the electro-thermal system may comprise a first electrical insulation film and optionally a second electrical insulation film extending in the longitudinal direction. The first electrical insulation film may be arranged to electrically insulate the leading edge of one of the suction and pressure side heating layers. The optional second electrical insulation film may be arranged to electrically insulate the leading edge of the other one of the suction and pressure side heating layers.

The first electrical insulation film and the optional second electrical insulation film may comprise an exterior portion, an interior portion, and an intermediate portion connecting the exterior portion and the interior portion.

The exterior portion may be arranged on an exterior side of the respective heating layer, the interior portion may be arranged on an interior side of the respective heating layer, and the intermediate portion may be arranged adjacent to the leading edge of the respective heating layer. The exterior portion and/or the interior portion may extend from the leading edge of the respective heating layer by a predetermined distance, e.g. of at least 30 mm, preferably at least 50 mm, more preferably at least 70 mm.

Preferably, the first electrical insulation film and the optional second electrical insulation film may longitudinally extend to electrically insulate the entire leading edge of the respective heating layer from a root end thereof to a tip end thereof.

The first electrical insulation film and/or the optional second electrical insulation film may comprise, or consist essentially of, an electrically insulating polymer film, e.g. a PET film, optionally reinforced with electrically insulating fibres, such as glass fibres.

In some embodiments, the inclusion of the first electrical insulation film and/or the optional second electrical insulation film may provide sufficient electrical insulation to reduce the risk of a flashover between the heating layers to allow omitting the equipotential bonding connections of heating layers.

Additionally or alternatively, the leading edge of the suction and pressure side heating layers may extend substantially along the longitudinal direction. The distance between the leading edges of the suction and pressure side heating layers may be substantially constant along the longitudinal direction. A constant distance may simplify the layup of the heating layers. In other embodiments, the distance between the leading edges of the suction and pressure side heating layers may vary. Varying the distance may allow tailoring the potential difference to the particular location along the longitudinal length. For example, the distance may vary from a first distance at the root portion of the heating layers to a second distance at the tip portion of the heating layers, the first distance may be greater than the second distance. The larger separation of the leading edge at the first distance may in effect provide additional insulation allowing a larger potential difference before a flashover event occurs. Further, the distance may change, e.g. decrease, linearly from the first distance to the second distance along the longitudinal direction.

Additionally or alternatively, the suction side heating layer, preferably the electrically conductive fibres of the suction side heating layer, and/or the suction side metallic lightning protection layer may be embedded in and co-infused with the suction side shell part. The pressure side heating layer, preferably the electrically conductive fibres of the pressure side heating layer, and/or the pressure side metallic lightning protection layer may be embedded in and co-infused with the pressure side shell part.

Embedding and co-infusing the suction and pressure side heating layers and the suction and pressure side metallic lightning protection layers with the respective shell part of the aerodynamic shell body may provide a smoother exterior surface for improved aerodynamic performance, especially when compared to arrangement wherein the heating layers and/or metallic lightning protection layers are overlaminated onto the aerodynamic shell body. In addition, arranging the suction and pressure side metallic lightning protection layers exteriorly and overlapping the suction and pressure side heating layers may reduce the risk of a lightning strike flashing to the heating layers.

Additionally or alternatively, the suction and pressure side metallic lightning protection layers may be configured to function as lightning receptors and/or for potential equalisation.

Additionally or alternatively, the suction and pressure side metallic lightning protection layers may be metallic meshes, preferably copper meshes, e.g. expanded copper meshes, or perforated copper meshes.

Additionally or alternatively, the electrically conductive fibres may be carbon fibres. The electrically conductive fibres may be arranged in one or more fibre layers, preferably biaxial. The fibre layers may be non-woven and/or may be arranged at +/−45 degrees relative to the longitudinal direction.

Additionally or alternatively, the power cable may comprise a first power conductor connected to a root portion of the suction and pressure side heating layers, and a second power conductor connected to a tip portion of the suction and pressure side heating layers. The root portion may be arranged towards the root of the wind turbine blade and the tip portion may be arranged towards the tip of the wind turbine blade.

In the context of the present disclosure, when two parts are “co-infused” it is understood that both parts are simultaneously infused with a resin and cured in the same process. Thus, co-infusing two fibre-reinforced parts, such as the suction and pressure side heating layers in the respective shell part of the aerodynamic shell body of the wind turbine blade, involves arranging dry fibres of the two fibre-reinforced parts in a mould, infusing them simultaneously in the same process with a resin, and causing or letting the resin cure. This contrasts with a process wherein two separately manufactured parts which are joined or a process of overlaminating one part onto another part.

Additionally or alternatively, the electro-thermal system may comprise an electrical insulation layer interposed between each of the suction and pressure side metallic lightning protection layers and the respective heating layer, the electrical insulation layer may be configured for preventing a lightning strike flashing to the suction and pressure side heating layers and may preferably be made of polyethylene terephthalate (PET), e.g. a PET film. The electrical insulation layer may be embedded in and co-infused with the respective shell part of the aerodynamic shell body.

Interposing an electrical insulation layer between the heating layer and the respective metallic lightning protection layers reduces the risk of damage to the heating layer in the event of a lightning strike while also reducing the risk of a short circuit between the heating layer and the respective metallic lightning protection layer during operation of the electro-thermal system.

The electrical insulation layers may be configured for preventing a lightning strike flashing to the heating layer by selecting the material of the electrical insulation layers and the positioning of the electrical insulation layers relative to the respective heating layer and the respective metallic lightning protection layers so that a flashover voltage required for flashing over an end of the metallic lightning protection layers to a corresponding end of the heating layers is greater than a puncture voltage required for the lightning strike to puncture through the electrical insulation layer. The flashover voltage and puncture voltage can for instance be obtained by experiments.

Additionally, the electrical insulation layer may comprise a laminate structure including a polymer film, e.g. a PET film, sandwiched between two fibre layers, preferably glass fibre layers. The laminate structure may be prefabricated prior to infusion and curing of the suction and pressure side heating layers, the suction and pressure side metallic lightning protection layers, and optionally the suction and pressure side electrical insulation layers. The laminate structure may comprise an adhesive bonding the polymer film to the fibre layers. The adhesive is preferably different from the resin used to cure the suction and pressure side heating layers, the suction and pressure side metallic lightning protection layers, and optionally the suction and pressure side electrical insulation layers.

Moreover, in embodiments wherein at least one or both of heating layers extends adjacent to the corresponding spar cap which would risk a flashover and/or puncture between the heating layer and spar cap, the electro-thermal system may advantageously comprise further electrical insulation layer(s) interposed between the corresponding spar cap(s) and the heating layer(s). The further electrical insulation layer(s) may be provided of the same material as the above electrical insulation layers and using the same layup process.

Additionally or alternatively, the suction and pressure side heating layers may comprise a root edge, and a tip edge. The suction and pressure side metallic lightning protection layers may comprise a root edge and a tip edge. The tip edge of the suction and pressure side metallic lightning protection layers may be positioned beyond the tip edge of the suction and pressure side heating layers towards the tip of the wind turbine blade and may be arranged with a longitudinal gap to the tip edge of the respective heating layers.

This may provide the advantage of further reducing the risk of a lightning strike near the tip of the wind turbine blade flashing onto the suction and pressure side heating layers instead of the respective metallic lightning protection layer.

Additionally or alternatively, the electrical insulation layer may comprise a root edge, a tip edge, a leading edge and a trailing edge. The suction and pressure side trailing edges of the electrical insulation layer may extend beyond, e.g. further towards the trailing edge, both the trailing edges of the suction and pressure side heating layers.

The edges of the suction and pressure side heating layers, the suction and pressure side metallic lightning protection layers, and the electrical insulation layer may be identified as follows. The root edge may be located closest to the root and the tip edge may be located closest to the tip. The trailing edge and trailing edge may extend substantially along the longitudinal direction. The trailing edge may be located in the suction side shell part and the trailing edge may be located in the pressure side shell part. Further, the suction and pressure side trailing edges are the outermost longitudinal edges, e.g. closest to the trailing edge.

Additionally, a trailing edge of the suction side electrical insulation layers may extend beyond a line or plane intersecting the trailing edge of the suction side heating layer and the trailing edge of the suction side metallic lightning protection layers. The trailing edge of the pressure side electrical insulation layer may extend beyond a line or plane intersecting the trailing edge of the pressure side heating layer and the trailing edge of the pressure side metallic lightning protection layer.

Additionally, the electro-thermal system may comprise a leading edge insulation layer made of an electrically insulating polymer material, preferably a PET film. The leading edge insulation layer may extend along and overlap the bond line at the leading edge. The leading edge insulation layer may extend transversely from the bond line and overlap the suction and pressure side metallic lightning protection layers along a circumference of the suction side shell part and the pressure side shell part.

By including a leading edge insulation layer, the risk of a lightning strike on the bond line puncturing through to the ends of heating layer parts adjacent to the bond line is reduced.

Additionally or alternatively, the suction and pressure side heating layers may comprise at least two carbon fibre mats adjacent to the bond line. This may ensure adequate heat is supplied at the bond line to mitigate ice formation.

Additionally or alternatively, the aerodynamic shell body may comprise a leading edge protection cap overlapping the bond line and preferably overlapping the leading edge insulation layer. The leading edge protection cap may have an exterior side exposed to the exterior of the wind turbine blade and may be configured for providing erosion resistance to the leading edge of the wind turbine blade. The leading edge protection cap may preferably comprise or consist essentially of polyurethane (PUR).

Additionally or alternatively, the electro-thermal system may comprise a first exterior layer covering the suction and pressure side metallic lightning protection layers. The first exterior layer may have an interior side covering the suction and pressure side metallic lightning protection layers. The first exterior layer may preferably comprise a paint, such as a polyurethane (PUR) paint, and/or a veil, such as a polyester-based veil. The first exterior layer may preferably be at most 0.8 mm thick, more preferably in the range of 0.1-0.4 mm, even more preferably 0.2-0.3 mm.

By covering the suction and pressure side metallic lightning protection layers by the first exterior layer, erosion of the suction and pressure side metallic lightning protection layers may be reduced. Further, providing the first exterior layer sufficiently thin may reduce the risk of a lightning strike flashing over the surface of the first exterior layer instead of through the first exterior layer to the suction and pressure side metallic lightning protection layers.

Additionally or alternatively, the first exterior layer may have an exterior side exposed to the exterior of the wind turbine blade. Alternatively, the aerodynamic shell body may comprise a second exterior layer arranged on the first exterior layer. The second exterior layer may have an exterior side exposed to the exterior of the wind turbine blade. The second exterior layer may be substantially flush with the first exterior layer and may be different from the first exterior layer. The second exterior layer may preferably be a gelcoat, preferably a polyester-based gelcoat.

Additionally or alternatively, the second exterior layer may not cover at least the suction and pressure side metallic lightning protection layers, and/or the remaining parts of the aerodynamic shell body.

Additionally or alternatively, the electro-thermal system may comprise a number of cable clamp devices including at least a first cable clamp device. The number of cable clamp devices may electrically connect the power cable and the down conductor to form an equipotential bonding connection at distinct longitudinal positions along the longitudinal direction between the root and the tip of the blade.

The cable clamps may advantageously provide an equipotential bonding connection between the power cable and the lightning cable to reduce or avoid any flashover in the event of a lightning strike attaching the blade and consequently reducing or even avoiding blade damage.

Additionally or alternatively, the power cable comprises a shielding, and the number of cable clamp devices are electrically connected to the shielding of the power cable.

Additionally or alternatively, the number of cable clamp devices may each comprise a housing and a metallic clamp part. Each metallic clamp part may receive and clamp the down conductor and the power cable, preferably the shielding of the power cable, to form an equipotential bonding connection. The housing may surround the metallic clamp part so as to electrically insulate the metallic clamp part and the equipotential bonding connection. The housing may comprise through holes accommodating the down conductor and the power cable. The housing may preferably be made of a polymer, such as polyurethane (PUR).

Additionally or alternatively, the electro-thermal system may comprise a number of surge protection devices including one or more first surge protection devices and/or one or more second surge protection devices and/or one or more third surge protection devices. The first surge protection devices may be connected to the suction and pressure side heating layers and to the down conductor. The second surge protection devices may be connected to the suction and pressure side heating layers and the suction and pressure side metallic lightning protection layers. The third surge protection devices may be connected to the down conductor and the power cable.

Additionally or alternatively, the electro-thermal system may comprise a number of temperature sensors including at least one exterior temperature sensor configured for sensing an exterior temperature of the wind turbine blade and/or at least one interior temperature sensor configured for sensing an interior temperature of the wind turbine blade.

Additionally or alternatively, the number of temperature sensors may be configured for providing temperature signals to a control device that may be arranged in the hub of the wind turbine. The control device may control the power supply to the suction and pressure side heating layers based on the temperature signals from the number of temperature sensors so as to mitigate ice formation on the wind turbine blade. The type of temperature sensors may be fibre-optic.

Additionally or alternatively, the electro-thermal system may comprise a tip receptor arranged at the tip of the wind turbine blade and configured for conducting current from a lightning strike, the tip receptor being electrically connected to the down conductor.

A second aspect of the present disclosure relates to a method of manufacturing an aerodynamic shell body for a wind turbine blade, preferably according to the first aspect of this disclosure. The method comprises the steps of laying up a heating layer comprising electrically conductive fibres, a metallic lightning protection layer, and an electrical insulation layer together with one or more shell layers of the aerodynamic shell body as dry layers (i.e. non-cured layers, e.g. only the fibres without resin) and subsequently co-infusing and curing the layers in a single vacuum assisted resin transfer moulding process so as to embed the heating layer, the metallic lightning protection layer, and the electrical insulation layer in an aerodynamic shell body. Preferably the heating layer, the metallic lightning protection layer, and the electrical insulation layer is thus embedded in one of suction and pressure side shell parts of the aerodynamic shell body, and the method is repeated to separately provide the other one of the suction and pressure side shell parts of the aerodynamic shell body. The suction and pressure side shell parts may then be closed and attached, optionally adhesively, via a bond line separating the suction and pressure side shell parts.

A third aspect of this disclosure is related to a method of method of manufacturing a wind turbine blade, preferably according to the first aspect of this disclosure. The method comprising the steps of:
providing:
   a suction side shell part comprising a suction side heating layer and a suction side metallic lightning protection layer, the suction side heating layer having electrically conductive fibres arranged at least in a leading edge section of the suction side shell part, wherein the suction side metallic lightning protection layer is arranged exteriorly to and overlapping the suction side heating layer and is configured for conducting current from a lightning strike, and
   a pressure side shell part comprising a pressure side heating layer and a pressure side metallic lightning protection layer, the pressure side heating layer having electrically conductive fibres arranged at least in a leading edge section of the pressure side shell part, wherein the pressure side metallic lightning protection layer is arranged exteriorly to and overlapping the pressure side heating layer and is configured for conducting current from a lightning strike;
connecting a power cable to the suction and pressure side heating layers, the power cable being configured for being connected to a power source, wherein the electrically conductive fibres of the heating layers are configured for, upon receiving electrical power from the power cable, supplying resistive heating to the exterior surface of the wind turbine blade so as to mitigate, such as to melt or prevent, ice formation on the wind turbine blade;
connecting a down conductor to the suction and pressure side metallic lightning protection layers so as to be able to conduct a lightning strike current from the suction and pressure side metallic lightning protection layers to a first end of the down conductor arranged at a root of the wind turbine blade;
closing the suction and pressure side shell parts along a bond line thereby forming an aerodynamic shell body, wherein a leading edge of the suction side heating layer and a leading edge of the pressure side heating layer are arranged adjacent to the bond line and are separated by a distance transverse to the bond line; and
electrically connecting the electrically conductive fibres of the suction side heating layer and the electrically conductive fibres of the pressure side heating layer via at least one equipotential bonding conductor so as to form equipotential bonding of the suction side heating layer and the pressure side heating layer.

Additionally, the suction and pressure side shell parts may be provided by a method according to the second aspect of this disclosure.

Additionally or alternatively, wherein the at least one equipotential bonding conductor may comprises at least one trailing edge equipotential bonding (TE-EB) conductor including a suction side conductor electrically connected to the electrically conductive fibres of the suction side heating layer, a pressure side conductor electrically connected to the electrically conductive fibres of the pressure side heating layer. The step of electrically connecting the electrically conductive fibres of the suction side heating layer and the electrically conductive fibres of the pressure side heating layer may comprises:
preferably forming a hole (148) through a suction side connector part (144) of the suction side conductor and a pressure side connector part (144′) of the pressure side conductor, e.g. by drilling from the exterior of the wind turbine blade; and/or
preferably arranging a bridging device (145) (e.g. a bridging conductor of the bridging device) in the hole; and/or
preferably electrically connecting (e.g. by applying a electrically conductive paste) the bridging device with the suction side connector part and the pressure side connector part so as to establish equipotential bonding between the electrically conductive fibres of the suction side heating layer and the electrically conductive fibres of the pressure side heating layer.

Additionally or alternatively, the at least one equipotential bonding conductor may comprise at least one leading edge equipotential bonding (LE-EB) conductor. The step of electrically connecting the electrically conductive fibres of the suction side heating layer and the electrically conductive fibres of the pressure side heating layer may comprises:
preferably forming at least one depression at the leading edge of the aerodynamic shell body, the depression may extend between the leading edge section of the suction side shell part and the leading edge section of the pressure side shell part; and/or
preferably arranging the leading edge equipotential bonding conductor in the at least one depression; and/or
preferably electrically connecting (e.g. by applying an electrically conductive paste) a suction side portion of the leading edge equipotential bonding conductor to the electrically conductive fibres of the suction side heating layer; and/or
preferably electrically connecting (e.g. by applying an electrically conductive paste) a pressure side portion of the leading edge equipotential bonding conductor to the electrically conductive fibres of the pressure side heating layer; and/or
preferably re-establishing an exterior surface of the aerodynamic shell body (e.g. by covering the LE-EB conductor by a layer such as a gelcoat.

Throughout the present disclosure, components of the wind turbine blade may be described as having “edges” or “portions” with a relative positioning term such as “leading”, “trailing”, “root” and “tip”. This is to be understood that the “root edge” of such a component is arranged towards the root end of the wind turbine blade without necessarily being arranged at the root end of the wind turbine blade. For example, the “trailing edge” of the suction side heating layer is arranged closer to the trailing edge of the wind turbine blade than the “leading edge” of the suction side heating layer, but does not necessarily intersect or coincide with the trailing edge of the wind turbine blade.

A person skilled in the art will appreciate that any one or more of the above aspects of this disclosure and embodiments thereof may be combined with any one or more of the other aspects of this disclosure and embodiments thereof.

### BRIEF DESCRIPTION OF THE DRAWINGS

Embodiments of this disclosure will be described in more detail in the following with regard to the accompanying figures. The figures show one way of implementing the present invention and are not to be construed as being limiting to other possible embodiments falling within the scope of the attached claim set.

FIG. 1 is a schematic perspective view of a wind turbine.

FIG. 2 is a schematic perspective view of a wind turbine blade having a longitudinal leading edge section for a wind turbine as shown in FIG. 1.

FIG. 3 is a schematic illustration along a longitudinal direction of an electro-thermal system incorporated into the longitudinal section of the wind turbine blade as shown in FIG. 2.

FIG. 4A is a schematic perspective view of a trailing edge equipotential bonding conductor of the electro-thermal system of FIG. 3 with exterior layers omitted for visualisation purposes.

FIG. 4B is a schematic perspective view of a suction side connector of the trailing edge equipotential bonding conductor of FIG. 4A. Additionally, the metallic lightning protection layer and electrical insulation layer are omitted for visualisation purposes.

FIG. 5A is a schematic cross-sectional view of the trailing edge equipotential bonding conductor of FIG. 4A.

FIG. 5B is a schematic detail view of a bridging device of the trailing edge equipotential bonding conductor at the dashed circle marked “A” of FIG. 5A.

FIG. 6A-6B are schematic views of another embodiment of a trailing edge equipotential bonding conductor. Only the suction and pressure side conductors are shown while the remaining layers of the wind turbine blade are omitted for visualisation purposes.

FIG. 7 is a schematic perspective view of a plurality of leading edge equipotential bonding conductors of the electro-thermal system of FIG. 3 with exterior layers omitted for visualisation purposes.

FIG. 8 is a schematic cross-sectional view of the longitudinal section of the wind turbine blade as shown in FIG. 2.

FIG. 9A-9C are schematic views of a cable clamp device.

### DETAILED DESCRIPTION OF THE INVENTION

In the following figure description, the same reference numbers refer to the same elements and may thus not be described in relation to all figures. Further, the prime suffix ‘is appended to a reference number denote the pressure side equivalent of that reference number. For example, the reference number 23 denotes the suction side spar cap and 23’ denotes the pressure side spar cap.

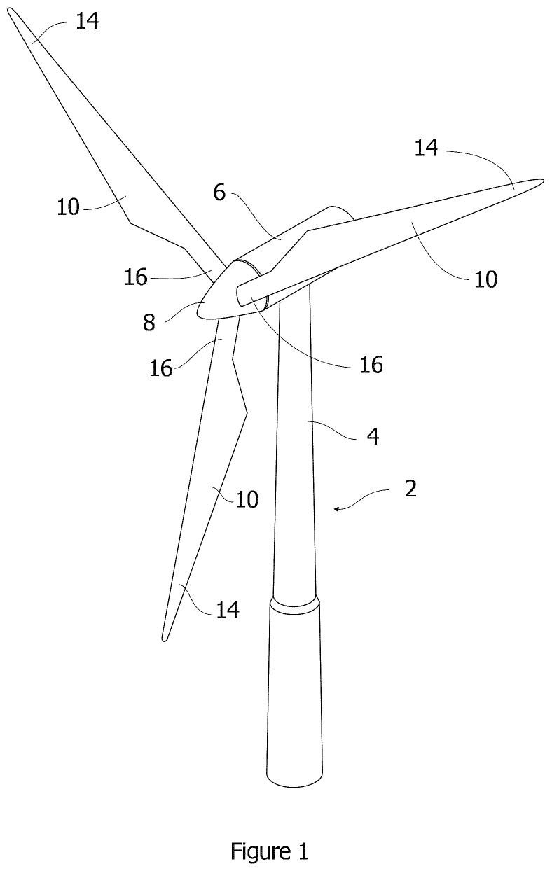

FIG. 1 illustrates a conventional modern upwind wind turbine 2 according to the so-called “Danish concept” with a tower 4, a nacelle 6 and a rotor with a substantially horizontal rotor shaft which may include a tilt angle of a few degrees. The rotor includes a hub 8 and three blades 10 extending radially from the hub 8, each having a blade root 16 nearest the hub and a blade tip 14 furthest from the hub 8.

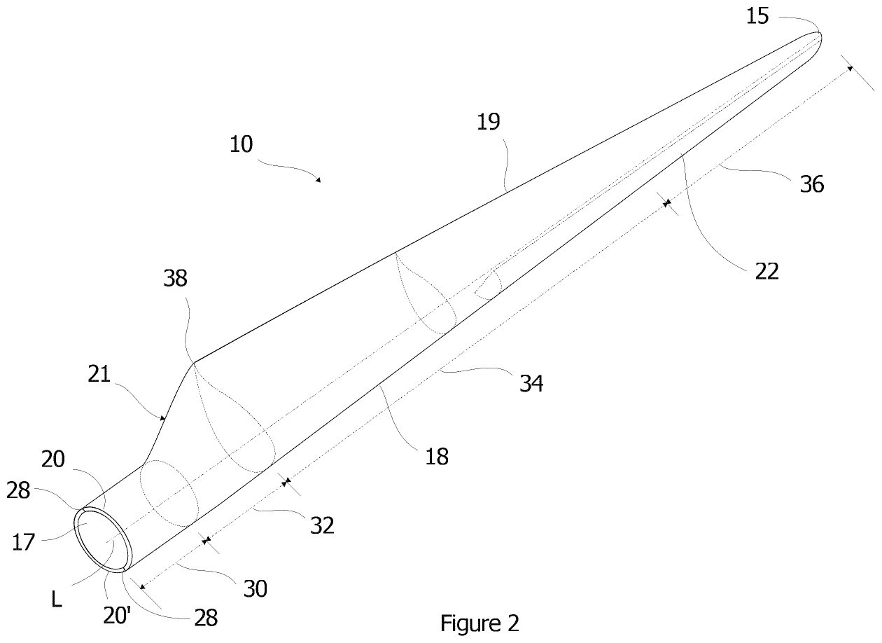

FIG. 2 shows a schematic view of an exemplary wind turbine blade 10. The wind turbine blade 10 has the shape of a conventional wind turbine blade with a root end 17 and a tip end 15 and comprises a root region 30 closest to the hub, a profiled or an airfoil region 34 furthest away from the hub and a transition region 32 between the root region 30 and the airfoil region 34. The blade 10 comprises a leading edge 18 facing the direction of rotation of the blade 10, when the blade is mounted on the hub 8, and a trailing edge 19 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root region 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 19 of the blade 10. The width of the chord decreases with increasing distance r from the hub.

A shoulder 38 of the blade 10 is defined as the position, where the blade 10 has its largest chord length. The shoulder 38 is typically provided at the boundary between the transition region 32 and the airfoil region 34.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The blade 10 is typically made from a suction side shell part 20 and a pressure side shell part 20′ that are glued to each other along the bond line 28 at the leading edge 18 and the trailing edge 19 of the blade to form an aerodynamic shell body 12 of the wind turbine blade 10.

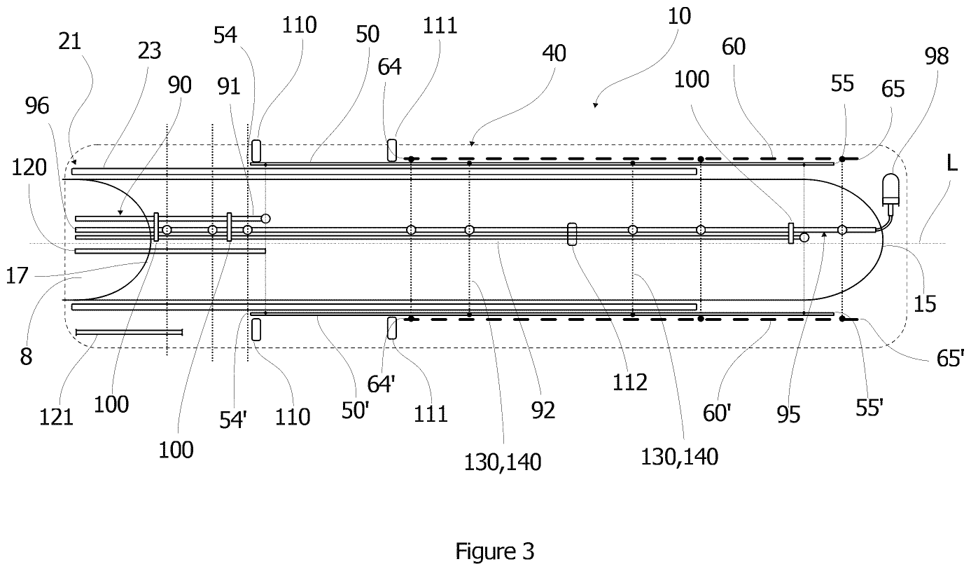

Turning to FIG. 3, electrical connections and the laminate structure of an electro-thermal system 40 incorporated in such an aerodynamic shell body 12 of the blade 10 are schematically illustrated. The electro-thermal system 40 is intended to mitigate, e.g. by preventing or melting, ice formation in the leading edge section 22 of the wind turbine blade as shown in FIG. 2.

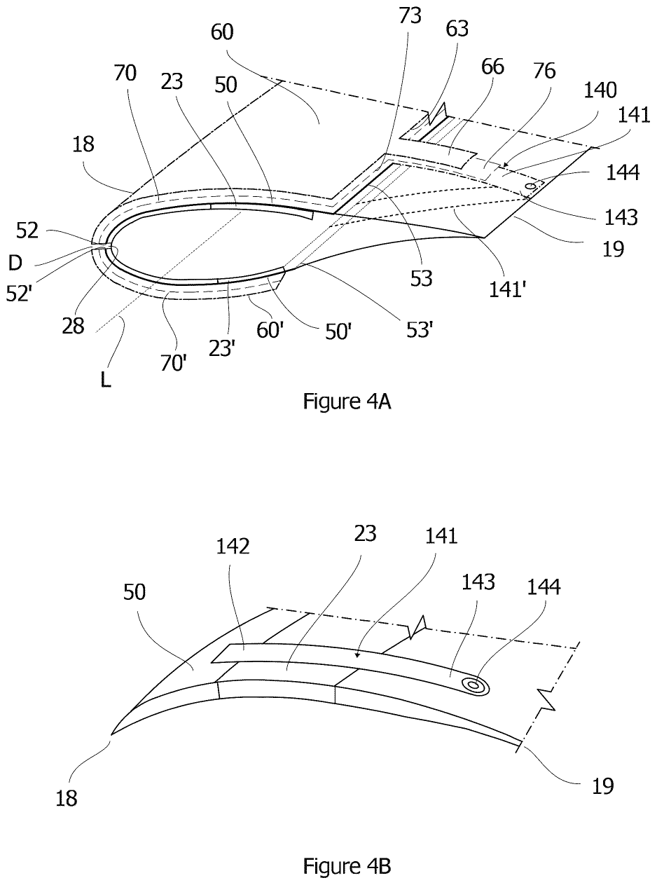

As best seen in FIG. 3, the electro-thermal system 40 comprises suction and pressure side heating layers 50, 50′. In the present embodiment, the suction and pressure side heating layers 50 comprise a non-woven biaxial carbon fibre mat arranged to extend substantially in the leading edge section 22 (shown in FIG. 2) and is oriented at +/−45 degrees relative to the longitudinal direction. However, other arrangements of the suction and pressure side heating layers 50, 50′ may be employed. The suction and pressure side heating layers 50, 50′ comprise a root edge 54, 54′ and a tip edge 54, 54′, respectively. As best seen in FIG. 4A, the suction and pressure side heating layers 50, 50′ further comprise a leading edge 52, 52′ and a trailing edge 53, 53′, respectively. In the following, the edges of the suction and pressure side heating layers, the suction and pressure side metallic lightning protection layers, and the suction and pressure side electrical insulation layers may be identified as follows. The root side and tip edges extend substantially in a transverse direction to the longitudinal direction, e.g. a chordwise direction, while the suction and pressure side trailing edges as well as any leading edges extend substantially in the longitudinal direction. The root edge is located closest to the root and the tip edge is located closest to the tip. A suction side trailing edge is at the suction side shell part 20 and a pressure side trailing edge is at the pressure side shell part 20′. Further, the trailing edges are the outermost longitudinal edges, e.g. closest to the trailing edge of the wind turbine blade.

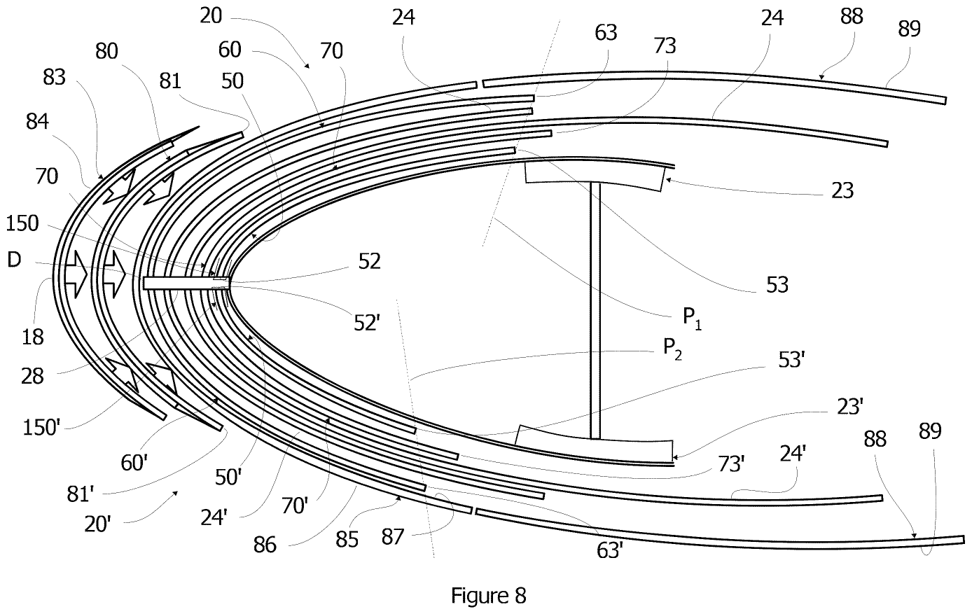

Returning to FIG. 3, the electro-thermal system 40 also comprises suction and pressure side metallic lightning protection layers 60, 60′ configured for conducting current from a lightning strike. In the present embodiment, the suction and pressure side metallic lightning protection layers 60, 60′ are in the form of an expanded or perforated copper mesh. The suction and pressure side metallic lightning protection layers 60, 60 are arranged exteriorly to and overlap the suction and pressure side heating layers 50, 50′, respectively, and thus reduce the risk of the lightning strike flashing to the suction and pressure side heating layers 50, 50′. The suction and pressure side metallic lightning protection layers 60, 60′ comprise a root edge 64, 64′ and a tip edge 65, 65′ respectively. As best seen in FIG. 8, the suction and pressure side metallic lightning protection layers 60, 60′ further comprise trailing edges 62, 62′, respectively. As best seen in FIG. 3, the tip edge 65, 65′ of the suction and pressure side metallic lightning protection layers 60, 60′ are positioned beyond the tip edge 55, 55′ of the suction and pressure side heating layers 50, 50′, respectively, towards the tip end 15 of the wind turbine blade, and are arranged with a longitudinal gap to the tip edge 55, 55′ of the suction and pressure side heating layers 50, 50′.

The electro-thermal system 40 further comprises a power cable 90 including a first power conductor 91 and a second power conductor 92. The first conductor 91 is electrically connected to a root portion of the suction and pressure side heating layers 50, 50′ and the second power conductor 92 is electrically connected to a tip portion of the suction and pressure side heating layers 50, 50′. The root portion is closer to the root of the wind turbine than the tip portion. A root end of the power cable 90 is configured for being connected to a power source which could for instance be located in the hub 8 or in the blade 10. Accordingly, the power cable 90 can supply power to the suction and pressure side heating layers 50, 50′. The electrically conductive carbon fibres of the suction and pressure side heating layers 50, 50′ can thus, upon receiving electrical power from the power cable 90, supply resistive heating to an exterior side of the leading edge section 22 of the wind turbine blade 10 and thus mitigate, e.g. by melting or preventing, ice formation on the wind turbine blade 10.

The electro-thermal system 40 includes a down conductor 95 that has a first end 96 arranged at the root of the wind turbine blade 10. The first end 96 is configured for being earthed via a down conductor of the hub 8. The down conductor 95 is electrically connected to the suction and pressure side metallic lightning protection layers 60, 60′ so as to be able to conduct a lightning strike current from the suction and pressure side metallic lightning protection layers 60, 60′ to the first end of the down conductor 95. An opposite end of the down conductor 95 at the tip end 15 of the wind turbine blade 10 is electrically connected to a tip receptor 98 of the electro-thermal system 40 configured for conducting current from a lightning strike at the tip 15.

The electro-thermal system 40 further comprises a plurality of equipotential bonding conductors 130, 140 electrically connecting the electrically conductive fibres of the suction side heating layer 50 and the electrically conductive fibres of the pressure side heating layer 50′ so as to form equipotential bonding of the suction side heating layer 50 and the pressure side heating layer 50′. Thus, the plurality of equipotential bonding conductors 130, 140 form an electrical connection separately from the power cable 90 (including the conductors 91, 92 of the power cable). In the present embodiment, the number of equipotential bonding conductors 130, 140 is two, however in other embodiments, the number of such equipotential bonding conductors may be just a single or even more than two. For example, the number may be at least 3, 4, 5, 6, 7, 8, 9, 10, 15, 20, or 25. Further, the plurality of equipotential bonding conductors may be distributed along the longitudinal direction L between the root edges 54, 54′ and the tip edges 55, 55′ of the suction and pressure side heating layers 50, 50′. The distance along the longitudinal direction L between adjacent equipotential bonding conductors 130, 140 may be at most 20 metres, preferably at most 15 metres, more preferably at most 10 metres, most preferably at most 5 metres.

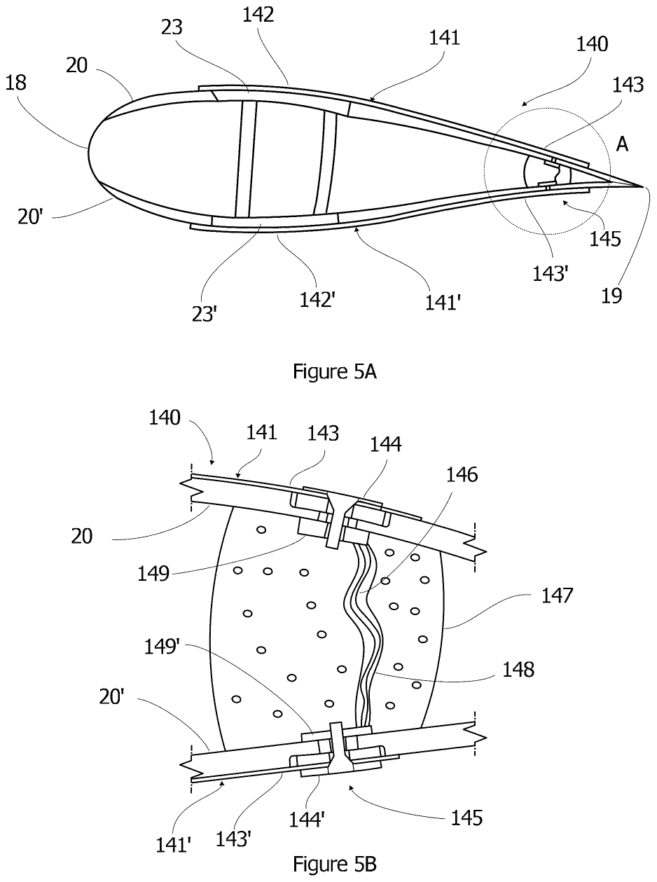

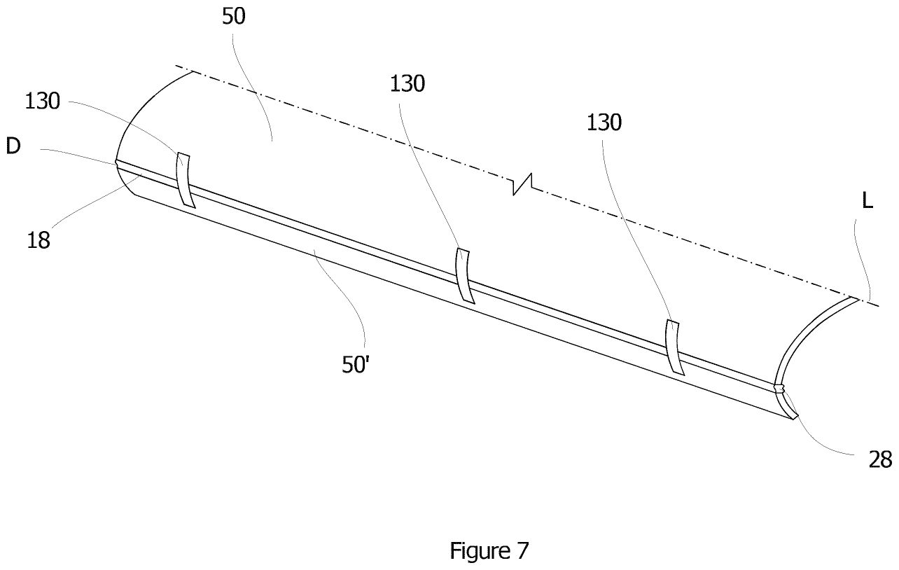

As shown in FIG. 4A, the leading edge 52 of the suction side heating layer 50 and the leading edge 52′ of the pressure side heating layers 50′ are arranged adjacent to the bond line 28 and are separated by a distance transverse to the bond line 28. During a lightning strike, a flashover event may occur over the bond line between the heating layers 50, 50′ if the potential difference between the heating layers 50, 50′ becomes too great. Further, the wind turbine blade comprises a suction side spar cap 23 and a pressure side spar cap 23′. A spar cap may also be known as a main laminate. A spar cap may be integrated in the respective shell part or may form part of a separately provided spar, e.g. a box spar. The spar caps comprise or consist essentially of electrically conductive fibres, such as a carbon fibre composite material, e.g. in the form of infused and cured carbon fibre sheets and/or carbon fibre pultrusions. As seen in FIGS. 4A and 5A, the suction side heating layer 50 overlaps entirely with the suction side spar cap 23, and the pressure side heating layer 50′ overlaps entirely with the pressure side spar cap 23′. In this context, the overlap is seen perpendicularly to the exterior surface of the wind turbine blade. In other words, the suction side heating layer 50 and the pressure side heating layer 50′ extend from the bond line 28 at the leading edge 18 and beyond the respective spar cap 23, 23′ towards the trailing edge 19. As mentioned above, the electro-thermal system 40 comprises equipotential bonding conductors 130, 140. These can be leading edge equipotential bonding conductors 130 (abbreviated as LE-EB conductors) and/or trailing edge equipotential bonding conductors 140 (abbreviated as TE-EB conductors). In FIGS. 4A-4B, 5A-5B, and 6A-6B, the structural build-up of a TE-EB conductor 140 is shown. The TE-EB conductor 140 is arranged in a trailing edge section of the suction and pressure side shell parts 20, 20′ and towards the trailing edge 19. As best seen in FIGS. 4A and 5A, the TE-EB conductor 140 comprises a suction side conductor 141 and a pressure side conductor 141′. The suction and pressure side conductors 141, 141′ are embedded in the suction and pressure side shell parts 20, 20′, respectively. The suction and pressure side conductors 141, 141′ consist essentially of an expanded copper mesh, but other conductive materials may be employed, such as bronze or aluminium. In FIG. 7, the structural build-up of LE-EB conductors 130 is shown.

As best seen in FIGS. 4B and 5A, the suction side conductor 141 comprises a leading edge portion 142 which is electrically connected to the electrically conductive fibres of the suction side heating layer 50, e.g. by being adjacent layers in the laminate stack of the suction side shell part 20′. In the present figure, the suction side conductor 141 (and thus also the pressure side conductor) including the leading portions 142 thereof, entirely overlaps with the suction side spar cap 23. In other embodiments, the suction and pressure side conductors, including the leading portion thereof, may be distanced from the spar caps (and may thus not overlap). As seen, the suction side electrical insulation layer 70 comprises a tongue portion 76 extending towards the trailing edge 19 and partly covers the extent of the suction side conductor 141 towards the trailing edge 19. The suction side metallic lightning protection layer 60 also comprises a tongue portion 66 extending towards the trailing edge 19 and partly covers the extent of the tongue portion 76 of the suction side electrical insulation layer 70 towards the trailing edge 19. This is arranged to provide lightning protection to the suction side conductor 141. The pressure side conductor is omitted from view in FIG. 4B, but the arrangement on the pressure side is similar to the arrangement shown on the suction side. Turning to FIGS. 5B, the TE-EB conductor 140 further comprises suction and pressure side connector parts 144, 144′ in electrical contact with a trailing portion 143, 143′ of the respective conductor 141, 141′. The connector parts 144, 144′ are solid and relatively thin conductive parts, such as plates, or discs, that are embedded within the respective shell part 20, 20′ and arranged on an outer side of the trailing portion 143, 143′ of the respective conductor 141, 141′. The solid connector parts 144, 144′ are made of copper but may be made of other conductive materials, such as bronze.

The TE-EB conductors 140 further comprise a bridging device 145 electrically connecting the trailing portion 143 of the suction side conductor 141 and the trailing portion 143′ of the pressure side conductor 141′ via the respective solid connector parts 144, 144′. The bridging device 145 comprises a bridging conductor 146 extending from the suction side connector part 144 to the pressure side connector part 144′. The bridging conductor 146 is provided in the form of a cable arranged with slack which allows the relatively flexible suction and pressure sides of the aerodynamic shell body near the trailing edge to flex in a thickness direction due to varying air pressures without compromising the function of the TE-EB conductors 140. The cable is encapsulated in a through hole cavity 148 of a block 147 arranged between the interior sides of the suction side shell part 20 and the pressure side shell part 20′. The block 147 is made of a resilient material, e.g. of a foamed polymer, that is configured to allow suction and pressure sides of the aerodynamic shell body at the trailing edge to flex in a thickness direction due to varying air pressures. In the embodiment shown in FIG. 5B, the bridging device 145 further comprises a suction side bolt assembly 149 and a pressure side bolt assembly 149′ forming the connection between the connector parts 144, 144′ and the bridging conductor 146. In alternative embodiments, the bolt assemblies may be omitted and a braiding of the cable may be spread out onto the solid connector parts 144, 144′ at both ends of the bridging device to ensure a good electrical contact.

Alternatively, the bridging conductor 146 may be a bolt (not shown). In such case, the trailing portion 143 of the suction side conductor 141 and the trailing portion 143′ of the pressure side conductor 141′ extend to a location adjacent to the trailing edge 19 which has a thickness of at most 20 cm, preferably at most 15 cm, more preferably at most 10 cm. A head of the bolt may be arranged in electrical contact with one of the trailing portions 143 of the suction side conductor 141 and the trailing portion 143′ of the pressure side conductor 141′, preferably the connector part 144, 144′ of the trailing portion of the respective conductor. An end arranged opposite of the head of the bolt may be arranged in electrical contact with the other one of the trailing portions of the suction side conductor and the trailing portion of the pressure side conductor, preferably the connector part of the trailing portion of the respective conductor, which may preferably comprise a nut for engaging and establishing electrical contact with the end of the bolt.

TE-EB conductors of a wind turbine blade may be assembled as follows. The suction and pressure side conductors 141, 141′ and the suction and pressure side connector parts 144, 144′ are embedded in the respective shell part 20, 20′. After the shell parts 20, 20′ are closed and adhered along the bond line 28 to form the aerodynamic shell body 12, a hole 148 is drilled from the exterior of the shell body 12 and extending through the connector parts 144, 144′. A bridging conductor 146, e.g. a cable, is inserted through the hole and electrically connected to the suction side connector part 144 at one end and to the pressure side connector part 144′ at the opposite end, e.g. by spreading a braiding of the cable onto the connector parts 144, 144′ and adhering with an electrically conductive adhesive. These steps are then repeated for the remaining TE-EB conductors.

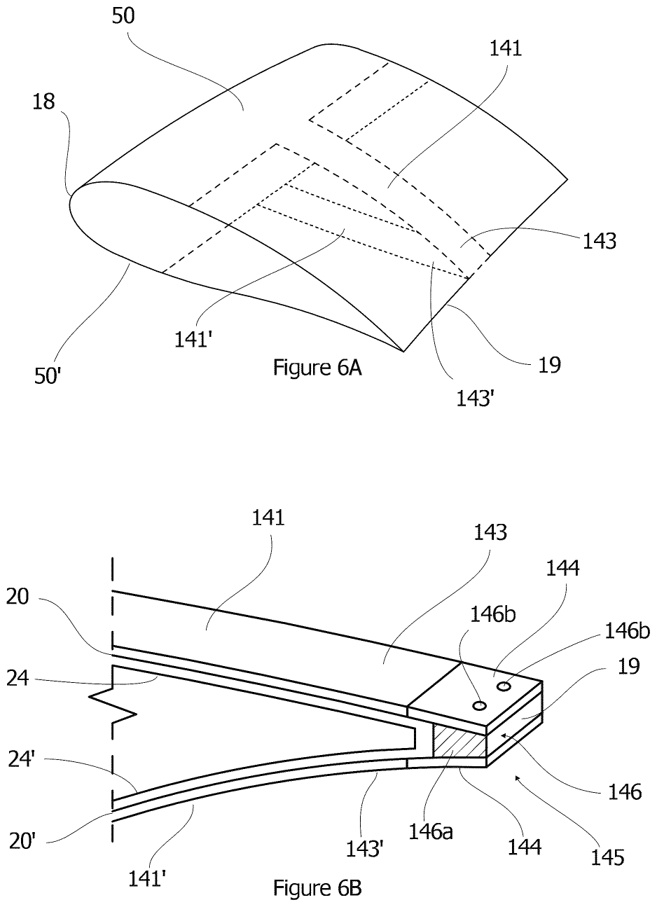

Turning to FIGS. 6A-6B, another embodiment of a TE-EB conductor 140 is shown. In this embodiment, the trailing portions 143, 143′ of the suction and pressure side conductors 141, 141′ of the TE-EP conductor 140 extend entirely to the trailing edge 19 of the wind turbine blade 10. A connector part 144 of the suction side conductor 141 defines the trailing edge of the suction side conductor 141 which coincides with the trailing edge 19 of the wind turbine blade 10. A connector part 144′ of the pressure side conductor 141 defines the trailing edge of the pressure side conductor 141 which also coincides with the trailing edge 19 of the wind turbine blade 10. The connector parts 144, 144′ are solid metal plates embedded within the respective suction and pressure side shell parts 20, 20′ together with the suction and pressure side conductors 141, 141′. A spacer 146a of a bridging device 145 is sandwiched between the trailing edge of the suction side conductor 141 and the trailing edge of the pressure side conductor 141′. The spacer is a metallic spacer and thus define a bridging conductor 146 of the bridging device 145. In addition, the bridging conductor 146 of the bridging device 145 comprise one or more metal tabs 146b (two is shown) arranged in respective holes 148 extending through the connector parts 144, 144′ of the suction and pressure side conductor 141, 141′ as well as the spacer 146a. The spacer is arranged between the suction and pressure side connector parts 144, 144′ during closure of the suction and pressure side shell parts 20, 20′. The holes 148 are either pre-drilled prior to the closure of the shell parts 20, 20′ or drilled after closing the suction and pressure side shell parts 20, 20′.

LE-EB conductors 130 of a wind turbine blade are best seen in FIG. 7 and may be assembled as follows. After the shell parts 20, 20′ are closed and adhered along the bond line 28 to form the aerodynamic shell body 12, a location for providing a LE-EB conductor is identified at the leading edge. A depression (not shown but is present beneath the shown LE-EB conductors 130) is formed at the leading edge, e.g. by grinding, exposing the electrically conductive fibres of the suction and pressure side heating layers 50, 50′. A strip of electrically conductive material, e.g. carbon fibres, is arranged in the depression and electrically connected to the exposed fibres of the suction and pressure side heating layers 50, 50′. The exterior surface at the formed depression is then re-established so as to maintain the aerodynamic exterior surface of the shell parts 20, 20′. These steps are then repeated for the remaining LE-EB conductors.

Turning to FIG. 8, the electric-thermal system 40 comprises suction side and pressure side electrical insulation layers 70, 70′ (omitted on FIG. 3) configured for preventing a lightning strike flashing to the respective heating layer. The suction and pressure side electrical insulation layers 70, 70′ are interposed between the suction and pressure side metallic lightning protection layers 60, 60′ and the suction and pressure side heating layers 50, 50′, respectively. In the present embodiment, the suction side and pressure side electrical insulation layers 70, 70′ are made of laminate structure including a polyethylene terephthalate (PET) film sandwiched between two glass fibre layers. Other arrangements may also provide sufficient electrical insulation. The suction side and pressure side electrical insulation layers 70, 70′ comprise trailing edges 73, 73′, respectively. The trailing edges 73, 73′ of the suction side and pressure side electrical insulation layers 70, 70′ extend beyond and further towards the trailing edge (not shown in FIG. 8 but lies opposite of the leading edge 18) than both the respective trailing edges 53, 53 of the suction and pressure side heating layers 50, 50′. In particular, the trailing edge 73 of the suction side electrical insulation layer 70 extends beyond a first plane P₁ intersecting the trailing edge 53 of the suction side heating layer 50 and the trailing edge 62 of the suction side metallic lightning protection layers 60. Correspondingly, the trailing edge 73′ of the pressure side electrical insulation layer 70′ extends beyond a second plane P₂ intersecting the trailing edge 53′ of the pressure side heating layers 50′ and the trailing edge 62′ of the pressure side metallic lightning protection layer 60′.

As best seen in FIG. 8, the wind turbine blade includes suction and pressure side electrical insulation films 150, 150′ made of a PET film that extend in the longitudinal direction substantially along the entire longitudinal length of the respective heating layer 50, 50′. The suction side electrical insulation film 150 insulates the leading edge 52 of the suction side heating layer 50, and the pressure side electrical insulation film 150′ insulates the leading edge 52′ of the pressure side heating layer 50′. The suction and pressure side electrical insulation films 150, 150′ each comprises an exterior portion, an interior portion, and an intermediate portion connecting the exterior portion and the interior portion. The exterior portion is arranged on an exterior side of the respective heating layer 50, 50′, the interior portion is arranged on an interior side of the respective heating layer 50, 50′, and the intermediate portion is arranged adjacent to the leading edge 52, 52′ of the respective heating layer 50, 50′. The exterior portion and the interior portion extend from the leading edge 52, 52′ of the respective heating layer 50, 50′ towards the trailing edge thereof by a predetermined distance, e.g. of at least 30 mm, so that the suction side electrical insulation film is arranged to electrically insulate the leading edge of the suction side heating layers, and so that the pressure side electrical insulation film is arranged to electrically insulate the leading edge of the pressure side heating layer. Thus, the potential limit before a flashover event occurs between the leading edges 52, 52′ can be increased.

In the present embodiment as best seen in FIG. 3, the electro-thermal system 40 comprises three cable clamp devices 100. The cable clamp devices 100 electrically connect a shielding (not shown) of the power cable 90 with the down conductor 95 to form an equipotential bonding connection at distinct longitudinal positions along the longitudinal direction between the root end 17 and the tip end 15 of the blade 10.

The electro-thermal system 40 further comprises four first surge protection devices 110 and a single second surge protection device 111. The four first surge protection devices 110 are electrically connected to the suction and pressure side heating layers 50, 50′ and the suction and pressure side metallic lightning protection layers 60, 60′ and configured for preventing a surge current in the suction and pressure side heating layers 50, 50′ when lightning strikes the wind turbine blade 10. The single second surge protection device is arranged between the down conductor 95 and the shielding of the power cable 90.

The electro-thermal system 40 further comprises an exterior temperature sensor 121 configured for sensing an exterior temperature of the wind turbine blade 10 and an interior temperature sensor 120 configured for sensing an interior temperature of the wind turbine blade 10. In some embodiments, the exterior temperature sensor 121 may be omitted. The temperature sensors 120, 121 are configured for providing temperature signals to a control device that can for instance be arranged in the nacelle 6 or hub 8 of the wind turbine 2. Such a control device may control the power supply to the suction and pressure side heating layers 50, 50′ based on the temperature signals from the temperature sensors 120, 121 so as to mitigate ice formation on the wind turbine blade. The interior temperature sensor may be fibre-optic while the exterior temperature sensor may be wireless.

The arrangement shown in FIG. 8 is obtained by laying up the suction and pressure side heating layers 50, 50′, the suction and pressure side metallic lightning protection layers 60, 60′, and the suction and pressure side electrical insulation layers 70, 70′ together with the remaining shell layers 24, 24′ (e.g. carbon or glass fibre layers and optionally core layers such as a foamed polymer or balsawood, however some parts, e.g. the spar cap 23, may be made from pultrusions such as carbon fibre pultrusions) of the aerodynamic shell body 12 as dry layers in a respective suction side shell mould and a pressure side shell mould (not shown) and subsequently infusing and curing the layers 50, 60, 70, 24 and the layers 50′, 60′, 70′, 24′ in a parallel vacuum assisted resin transfer moulding process. Accordingly, the suction and pressure side heating layers 50, 50′, the suction and pressure side metallic lightning protection layers 60, 60′, and the suction and pressure side electrical insulation layers 70, 70′ are embedded in and co-infused with the respective suction and pressure shell part 20, 20′ of the aerodynamic shell body 12.

As best seen in FIG. 8, the aerodynamic shell body 12 comprises a longitudinally extending bond line 28 between the suction side shell part 20 and the pressure side shell part 20′. At the leading edge 18, the bond line 28 divides the suction and pressure side heating layers 50, 50′, the suction and pressure side metallic lightning protection layers 60, 60′, and the suction and pressure side electrical insulation layers 70, 70′. The suction side heating layer 50, the suction side metallic lightning protection layer 60, and the suction side electrical insulation layer 70 are embedded in and co-infused with the suction side shell part 20 while the pressure side heating layer 50′, the pressure side metallic lightning protection layer 60′, and the pressure side electrical insulation layer 70′ are embedded in and co-infused with the pressure side shell part 20′.

In order to electrically insulate the ends of the suction and pressure side heating layers 50, 50′ adjacent to the bond line 28, the electro-thermal system 40 comprises a leading edge insulation layer 80 made of an electrically insulating PET film. As shown in FIG. 8, the leading edge insulation layer 80 extends along and overlap the bond line 28 at the leading edge 18. The leading edge insulation layer has a trailing edge 81 and a trailing edge 81′ distanced from the bond line 28 along a circumference of the aerodynamic shell body 12. Thus, the leading edge insulation layer 80 extends transversely from the bond line 28 and overlaps the suction and pressure side metallic lightning protection layers 60, 60′ along a circumference of the aerodynamic shell body 12 as best seen in FIG. 8.

As shown in FIG. 8, the aerodynamic shell body 12 comprises a leading edge protection cap 83 that overlaps the bond line 28 and the leading edge insulation layer 80. The leading edge protection cap 83 is configured for providing erosion resistance to the leading edge 18 of the wind turbine blade 10 and has an exterior side 84 that is exposed to the exterior of the wind turbine blade 10. The leading edge protection cap 83 consists essentially of polyurethane (PUR). The suction and pressure side trailing edges 81, 81′ of the leading edge insulation layer 80 extends further towards the trailing edge (omitted on FIG. 8) than a suction and pressure side trailing edge of the leading edge protection cap 83, respectively. An edge-sealing material is provided between the respective trailing edges of the leading edge insulation layer 80 and the leading edge protection cap 83 and between the respective trailing edges of the leading edge insulation layer 80 and the leading edge protection cap 83. The edge-sealing material is for smoothing the surface transition between the layers to reduce turbulence.

The electro-thermal system 40 further comprises a first exterior layer 85 covering the suction and pressure side metallic lightning protection layers 60, 60′. The first exterior layer 85 has an interior side 87 facing and covering the suction and pressure side metallic lightning protection layers 60, 60′ and has an exterior side 86 that is partly exposed to the exterior of the wind turbine blade 10 and partly covered by the leading edge protection cap 83. The first exterior layer is a polyurethane (PUR) paint and is relatively thin being in the range of 0.2-0.3 mm thick.

The aerodynamic shell body 12 comprises a second exterior layer 88 that has an exterior side 89 exposed to the exterior of the wind turbine blade 10. The second exterior layer 88 is substantially flush with the first exterior layer 85. The second exterior layer 88 does not cover the suction and pressure side metallic lightning protection layers 60, 60′ but instead covers the remaining exposed parts of the aerodynamic shell body 12. The second exterior layer 88 is formed of a different material than the first exterior layer 85. In the present embodiment, second exterior layer 88 is a polyester-based gelcoat.

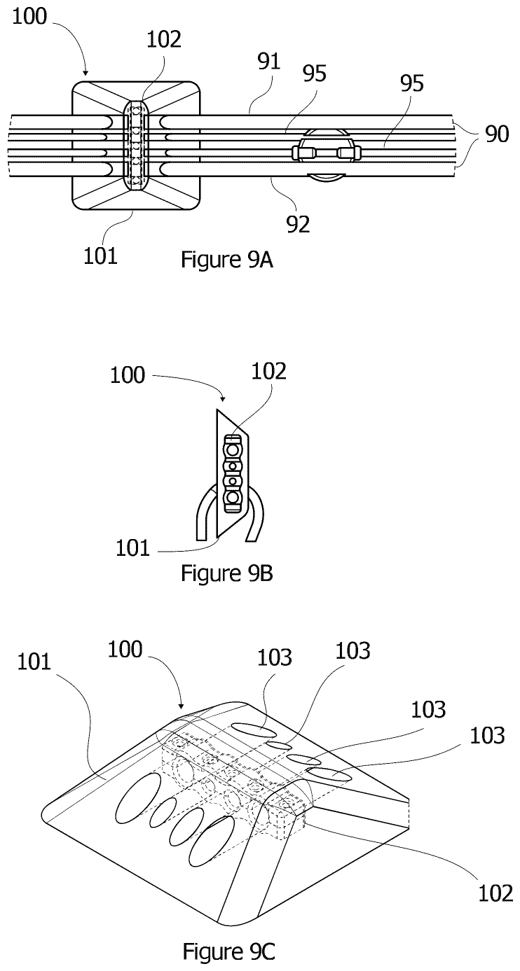

As best seen in FIG. 9A-9C, each cable clamp device 100 comprises a polymer housing 101 and a metallic clamp part 102. The metallic clamp part 102 receives and clamps the down conductor 95 and the shielding of the power conductors 91, 92 of the power cable 90 to form the equipotential bonding connection. The housing 101 surrounds the metallic clamp part 101 so as to electrically insulate the metallic clamp part 101 and the equipotential bonding connection. As best seen in FIG. 9C, the housing 101 comprises four through holes 103 accommodating the down conductor 95 and the power conductors 91, 92. In other embodiments, the housing 101 and metallic clamp part 102 may comprise three or even two through holes, such as when the electro-thermal system comprises a single down conductor 95 and a single power cable 90.

### LIST OF REFERENCES

| | |
|---|---|
| 2 | wind turbine |
| 4 | tower |
| 6 | nacelle |
| 8 | hub |
| 10 | blade |
| 12 | shell |
| 14 | blade tip |
| 15 | tip end |
| 16 | blade root |
| 17 | root end |
| 18 | leading edge |
| 19 | trailing edge |
| 20 | suction side shell part |
| 22 | leading edge section |
| 23 | spar cap |
| 24 | shell layer |
| 25 | trailing edge section |
| 20′ | pressure side shell part |
| 22′ | leading edge section |
| 23′ | spar cap |
| 24′ | shell layer |
| 25′ | trailing edge section |
| 28 | bond line |
| 30 | root region |
| 32 | transition region |
| 34 | airfoil region |
| 36 | tip region |
| 38 | shoulder |
| 40 | electro-thermal system |
| 50 | suction side heating layer |
| 52 | leading edge |
| 53 | trailing edge |
| 54 | root edge |
| 55 | tip edge |
| 50′ | pressure side heating layer |
| 52′ | leading edge |
| 53′ | trailing edge |
| 54′ | root edge |
| 55′ | tip edge |
| 60 | suction side metallic lightning |
| | protection layer |
| 63 | trailing edge |
| 64 | root edge |
| 65 | tip edge |
| 66 | tongue portion |
| 60′ | pressure side metallic lightning |
| | protection layer |
| 63′ | trailing edge |
| 64′ | root edge |
| 65′ | tip edge |
| 70 | suction side electrical insulation |
| | layer |
| 73 | trailing edge |
| 76 | tongue portion |
| 70′ | pressure side electrical insulation |
| | layer |
| 73′ | trailing edge |
| 80 | leading edge insulation layer |
| 81 | suction side trailing edge |
| 81′ | pressure side trailing edge |
| 83 | leading edge protection cap |
| 84 | exterior side |
| 85 | first exterior layer |
| 86 | exterior side |
| 87 | interior side |
| 88 | second exterior layer |
| 89 | exterior side |
| 90 | power cable |
| 91 | first power conductor |
| 92 | second power conductor |
| 95 | down conductor |
| 96 | first end |
| 98 | tip receptor |
| 100 | cable clamp device |
| 101 | housing part |
| 102 | metallic clamp part |
| 103 | through hole |
| 110 | first surge protection device |
| 111 | second surge protection device |
| 112 | third surge protection device |
| 120 | interior temperature sensor |
| 121 | exterior temperature sensor |
| 130 | LE-EB conductor |
| 140 | TE-EB conductor |
| 141 | suction side conductor |
| 142 | leading portion |
| 143 | trailing portion |
| 144 | connector part |
| 141′ | pressure side conductor |
| 142′ | leading portion |
| 143′ | trailing portion |
| 144′ | connector part |
| 145 | bridging device |
| 146 | bridging conductor |
| 146a | spacer |
| 146b | tab |
| 147 | block |
| 148 | through hole |
| 149 | suction side bolt assembly |
| 149′ | pressure side bolt assembly |
| 150 | suction side electrical insulation film |
| 150′ | pressure side electrical insulation |
| | film |
| D | distance |
| L | longitudinal direction |
| P₁ | first plane |
| P₂ | second plane |

1. A wind turbine blade (10) comprising:
an aerodynamic shell body (12) extending in a longitudinal direction (L) between a root end (17) and a tip end (15) and in a transverse direction between a leading edge (18) and a trailing edge (19), the aerodynamic shell body comprises a suction side shell part (20), a pressure side shell part (20′) and a longitudinally extending bond line (28) between the suction side shell part and the pressure side shell part, and
an electro-thermal system (40) for mitigating ice formation on the wind turbine blade, the electro-thermal system comprising:
a suction side heating layer (50) forming part of the suction side shell part of the aerodynamic shell body, the suction side heating layer comprising electrically conductive fibres arranged at least in a leading edge section (22) of the suction side shell part;
a pressure side heating layer (50′) forming part of the pressure side shell part of the aerodynamic shell body, the pressure side heating layer comprising electrically conductive fibres arranged at least in a leading edge section (22′) of the pressure side shell part;
a power cable (90) configured for supplying power to the suction and pressure side heating layers and configured for being connected to a power source, wherein the electrically conductive fibres of the heating layers are configured for, upon receiving electrical power from the power cable, supplying resistive heating to the exterior surface of the wind turbine blade;
a suction side metallic lightning protection layer (60) arranged exteriorly to and overlapping the suction side heating layer and being configured for conducting current from a lightning strike;
a pressure side metallic lightning protection layer (60′) arranged exteriorly to and overlapping the pressure side heating layer and being configured for conducting current from a lightning strike; and
a down conductor (95) having a first end (96) arranged at the root of the wind turbine blade configured for being earthed, the down conductor being electrically connected to the suction and pressure side metallic lightning protection layers so as to be able to conduct a lightning strike current from the suction and pressure side metallic lightning protection layers to the first end of the down conductor;
wherein a leading edge (52) of the suction side heating layer and a leading edge (52′) of the pressure side heating layer are arranged adjacent to the bond line and are separated by a distance (D) transverse to the bond line, wherein the electro-thermal system comprises at least one equipotential bonding conductor (130, 140) electrically connecting the electrically conductive fibres of the suction side heating layer and the electrically conductive fibres of the pressure side heating layer so as to form equipotential bonding of the suction side heating layer and the pressure side heating layer.

2. A wind turbine blade according to claim 1, wherein the suction side shell part comprises a suction side spar cap (23) and the pressure side shell part comprises a pressure side spar cap (23′), the suction side spar cap and pressure side spar cap comprising electrically conductive fibres, wherein the suction side heating layer is arranged to overlap at least partially with the electrically conductive fibres of the suction side spar cap, and/or the pressure side heating layer is arranged to overlap at least partially with the electrically conductive fibres of the pressure side spar cap.

3. A wind turbine blade according to claim 1, wherein the at least one equipotential bonding conductor forms part of a plurality of equipotential bonding conductors distributed along the longitudinal direction, the distance along the longitudinal direction between adjacent equipotential bonding conductors of the plurality of equipotential bonding conductor is at most 20 metres.

4. A wind turbine blade according to claim 1, wherein the at least one equipotential bonding conductor may comprise at least one trailing edge equipotential bonding (TE-EB) conductor (140) arranged in a trailing edge section (25, 25′) of the suction and pressure side shell parts.

5. A wind turbine blade according to claim 4, wherein the at least one TE-EB conductor comprises a suction side conductor (141), a pressure side conductor (141′), and a bridging device (145), wherein a leading portion (142) of the suction side conductor is electrically connected to the electrically conductive fibres of the suction side heating layer, and wherein a leading portion (142′) of pressure side conductor is electrically connected to the electrically conductive fibres of the pressure side heating layer, wherein the bridging device forms an electrical contact between a trailing portion (143) of the suction side conductor and a trailing portion (143′) of the pressure side conductor.

6. A wind turbine blade according to claim 5, wherein the TE-EB conductor comprises suction and pressure side connector parts (144, 144′) arranged in electrical contact with the respective conductor, wherein the bridging device forms the electrical contact via the suction side connector part and the pressure side connector part.

7. A wind turbine blade according to claim 5, wherein the suction side conductor is embedded in the suction side shell part, and wherein the pressure side conductor is embedded in the pressure side shell part.

8. A wind turbine blade according to claim 5, wherein the bridging device comprises a bridging conductor (146) extending from the suction side conductor, preferably the suction side connector part, to the pressure side conductor, preferably the pressure side connector part, wherein the bridging conductor is arranged with slack.

9. A wind turbine blade according to claim 8, wherein the bridging device comprises a retaining member (147) arranged between the interior sides of the suction side shell part and the pressure side shell part, and wherein the bridging conductor extends through and is arranged with slack in a cavity, e.g. a hole, of the retaining member, wherein the retaining member comprises a resilient material configured to allow suction and pressure sides of the aerodynamic shell body at the trailing edge to flex in a thickness direction due to varying air pressures.

10. A wind turbine blade according to claim 8, wherein the at least one equipotential bonding conductor comprises at least one leading edge equipotential bonding (LE-EB) conductor (130) arranged in the leading edge section of the suction and pressure shell parts.

11. A wind turbine blade according to claim 8, wherein the distance between the leading edges of the suction and pressure side heating layers varies along the longitudinal direction from a first distance at a root edge (54, 54′) of the heating layers to a second distance at a tip edge (55, 55′) of the heating layers, the first distance being greater than the second distance.

12. A wind turbine blade according to claim 8, wherein the electro-thermal system comprises a suction side electrical insulation film (150) and/or a pressure side electrical insulation film (150′) extending in the longitudinal direction, the suction side electrical insulation film and the pressure side electrical insulation film each comprises an exterior portion, an interior portion, and an intermediate portion connecting the exterior portion and the interior portion, wherein the exterior portion is arranged on an exterior side of the respective heating layer, the interior portion is arranged on an interior side of the respective heating layer, and the intermediate portion is arranged adjacent to the leading edge of the respective heating layer, the exterior portion and/or the interior portion extend from the leading edge of the respective heating layer towards the trailing edge thereof by a predetermined distance, e.g. of at least 30 mm, so that the suction side electrical insulation film is arranged to electrically insulate the leading edge of the suction side heating layer, and so that the pressure side electrical insulation film is arranged to electrically insulate the leading edge of the pressure side heating layer.

13. A method of manufacturing a wind turbine blade (10) according to claim 8, comprising the steps of:
providing:
a suction side shell part (20) comprising a suction side heating layer (50) and a suction side metallic lightning protection layer (60), the suction side heating layer having electrically conductive fibres arranged at least in a leading edge section (22) of the suction side shell part, wherein the suction side metallic lightning protection layer is arranged exteriorly to and overlapping the suction side heating layer and is configured for conducting current from a lightning strike, and
a pressure side shell part (20′) comprising a pressure side heating layer (50′) and a pressure side metallic lightning protection layer (60′), the pressure side heating layer (50′) having electrically conductive fibres arranged at least in a leading edge section (22′) of the pressure side shell part, wherein the pressure side metallic lightning protection layer (60′) is arranged exteriorly to and overlapping the pressure side heating layer and is configured for conducting current from a lightning strike;
connecting a power cable (90) to the suction and pressure side heating layers, the power cable being configured for being connected to a power source, wherein the electrically conductive fibres of the heating layers are configured for, upon receiving electrical power from the power cable, supplying resistive heating to the exterior surface of the wind turbine blade so as to mitigate, such as to melt or prevent, ice formation on the wind turbine blade;
connecting a down conductor (95) to the suction and pressure side metallic lightning protection layers so as to be able to conduct a lightning strike current from the suction and pressure side metallic lightning protection layers to a first end of the down conductor arranged at a root of the wind turbine blade;
closing the suction and pressure side shell parts along a bond line (28) thereby forming an aerodynamic shell body (12), wherein a leading edge (52) of the suction side heating layer and a leading edge (52′) of the pressure side heating layer are arranged adjacent to the bond line and are separated by a distance (D) transverse to the bond line; and
electrically connecting the electrically conductive fibres of the suction side heating layer and the electrically conductive fibres of the pressure side heating layer via at least one equipotential bonding conductor (130, 140) so as to form equipotential bonding of the suction side heating layer and the pressure side heating layer.

14. A method according to claim 13, wherein the at least one equipotential bonding conductor comprises at least one trailing edge equipotential bonding (TE-EB) conductor (140) including a suction side conductor (141) electrically connected to the electrically conductive fibres of the suction side heating layer, a pressure side conductor (141′) electrically connected to the electrically conductive fibres of the pressure side heating layer, and wherein step of electrically connecting the electrically conductive fibres of the suction side heating layer and the electrically conductive fibres of the pressure side heating layer comprises:
forming a hole (148) through a suction side connector part (144) of the suction side conductor and a pressure side connector part (144′) of the pressure side conductor, e.g. by drilling from the exterior of the wind turbine blade;
arranging a bridging device (145) in the hole; and
electrically connecting the bridging device with the suction side connector part and the pressure side connector part so as to establish equipotential bonding between the electrically conductive fibres of the suction side heating layer and the electrically conductive fibres of the pressure side heating layer.

15. A method according to claim 13, wherein the at least one equipotential bonding conductor comprises at least one leading edge equipotential bonding (LE-EB) conductor (130), and wherein step of electrically connecting the electrically conductive fibres of the suction side heating layer and the electrically conductive fibres of the pressure side heating layer comprises:
forming at least one depression at the leading edge of the aerodynamic shell body, the depression extending between the leading edge section of the suction side shell part and the leading edge section of the pressure side shell part;
arranging the leading edge equipotential bonding conductor in the depression;
electrically connecting a suction side portion of the leading edge equipotential bonding conductor to the electrically conductive fibres of the suction side heating layer;
electrically connecting a pressure side portion of the leading edge equipotential bonding conductor to the electrically conductive fibres of the pressure side heating layer; and
preferably re-establishing an exterior surface of the aerodynamic shell body.
